(19) United States
(12) Patent Application Publication
(10) Pub. No.: US 2020/0041350 A1
(43) Pub. Date: Feb. 6, 2020

(54) SHACK-HARTMANN WAVEFRONT DETECTOR FOR WAVEFRONT ERROR MEASUREMENT OF HIGHER NUMERICAL APERTURE OPTICAL SYSTEMS

(71) Applicant: Meopta -optika, s.r.o., Prerov (CZ)

(72) Inventors: Libor Ulehla, Prostejov (CZ); Lucie Celechovska, Lazniky (CZ); Libor Motka, Prerov (CZ); Bohumil Stoklasa, Prostejov (CZ); Petr Lezak, Drevohostice (CZ)

(21) Appl. No.: 16/528,740

(22) Filed: Aug. 1, 2019

Related U.S. Application Data
(60) Provisional application No. 62/714,116, filed on Aug. 3, 2018.

(51) Int. Cl. G01J 9/00; G02B 3/00

(52) U.S. Cl. CPC G01J 9/00; G02B 7/10; G02B 3/0056

(57) ABSTRACT

A device and method that belongs to the field of Shack-Hartmann (S-H) wavefront detection, more specifically an adaption of the S-H sensor, with an attachment of customized focusing relay optics, onto opto-mechanical measurement instrument for the alignment and measurement of an optical systems with a higher numerical aperture (NA), where the object points are realized by an object plate from a suitable material with single mode fibers light sources polished to achieve the same plane as said object plate is disclosed.

### CROSS-REFERENCE TO RELATED APPLICATION

The present application claims the benefit of previously filed co-pending Provisional Patent Application, Ser. No. 62/714,116, filed on Aug. 3, 2018.

### FIELD OF THE INVENTION

The device and method of this disclosure belongs to the field of Shack-Hartmann (S-H) wavefront detection. More specifically, it is an adaption of the S-H sensor, with an attachment of customized focusing relay optics onto opto-mechanical measurement instruments, for the alignment and measurement of projection optical systems with higher numerical apertures (NAs).

### BACKGROUND OF THE INVENTION

Wavefront sensing based on the Shack-Hartmann (S-H) principle is a known and commonly used method to visualize and quantify wavefront aberrations, or wavefront error (WFE), of an incoming light beam. Typical usage of S-H sensors is for the characterization of collimated beams, mostly in ophthalmology and metrology. Due to the relative insensitivity to vibrations, wavelength region and spectral bandwidth, S-H detection is a very good process for real time wavefront detection during alignment of afocal optical systems, i.e. optical systems without focus.

Thus there is a need for an adaption of the S-H sensor for the alignment of projection optical systems with higher numerical apertures (NAs).

### BRIEF SUMMARY OF THE INVENTION

What is disclosed is the adaptation of Shack-Hartmann wavefront sensor, including the S-H sensor (camera and appropriate Micro-Lens Array (MLA)), with an attachment of customized focusing relay optics, in combination with array of point light sources for use of alignment and measurement of projection optical systems with a higher numerical aperture. The S-H sensor's relay optics are specifically designed for the working numerical aperture of the Unit Under Test (UUT).

### BRIEF DESCRIPTION OF THE DRAWINGS

For a fuller understanding of the nature and objects of the invention, reference should be made to the following detailed description, taken in connection with the accompanying drawing, in which:

FIG. 1 shows a preferred embodiment optical/mechanical diagram of the focusing relay optics and point source for use with a S-H sensor on a Unit Under Test.

### DESCRIPTION OF THE PREFERRED EMBODIMENT

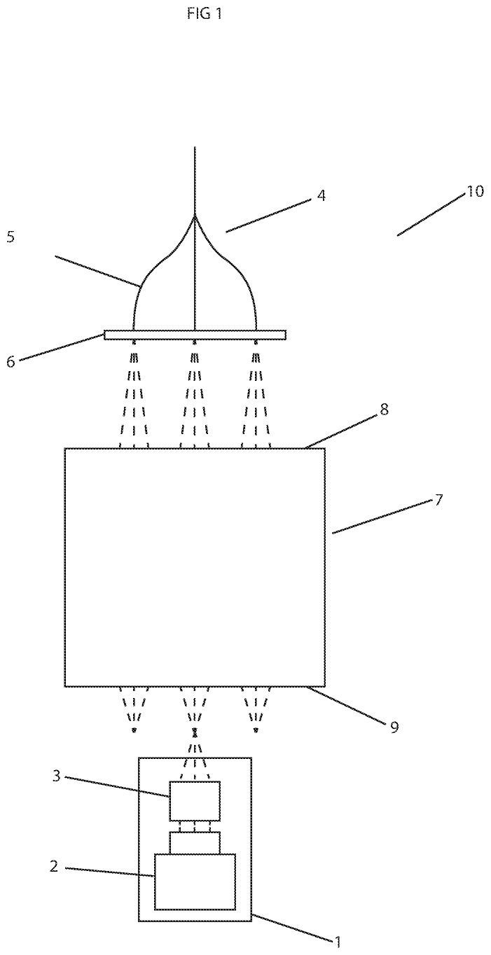

A Crucial part of the functionality of the focusing S-H sensor (1) is a 2-step calibration process. Referring to FIG. 1 the first step is calibration of the S-H sensor (2) itself by use of a plane wave, which removes the optical aberrations of the S-H sensor (2). The second step is calibration of the focusing S-H sensor (1) (S-H sensor (2)+focusing relay optics (3)) by using an ideal point source to remove optical aberrations (i.e. detect wavefront errors) of the focusing relay optics (3), and respectively, the whole detection system (10).

The focusing S-H sensor (1) is used mainly in the metrological process of alignment and wavefront measurement of a projection optical system, the Unit Under Test (7). Using an array of point light sources (4) an individual point light source is projected by the Unit Under Test's (7) optical system onto the image plane (9). The focusing S-H sensor (1) is placed so that the image of the point source that is projected by the Unit Under Test (7) is matched to the focal length of the focusing relay optics (3) of the focusing S-H sensor (1).

As also shown in FIG. 1 the array of point light sources (4) is created by a number of single mode fibers (5) placed in specific positions of the Unit Under Test's (7) object Field Of View (FOV) (8). In the preferred embodiment, a number of these single mode fibers (5) are precisely placed into an object plate made from a suitable material such as stainless steel, glass, etc. (6). The object plate (6) along with the output ends of the single mode fibers (5) are finely polished to achieve the same object plane position for all the single mode fibers (5) as well as the surface of the object plate (6).

Measurement of all the specific FOV positions is realized when each of the measured single mode fibers (5) are gradually turned on and the focusing S-H sensor (1) scans to each corresponding image position.

Since certain changes may be made in the above described adaptation of a Shack-Hartmann wavefront sensor, including the S-H sensor (2) (camera and appropriate Micro-Lens Array (MLA)), with an attachment of customized focusing relay optics (3) without departing from the scope of the invention herein involved, it is intended that all matter contained in the description thereof or shown in the accompanying FIGURE shall be interpreted as illustrative and not in a limiting sense.

What is claimed is:

1. A Focusing Shack-Hartmann Sensor comprising:
a Shack-Hartmann Sensor comprised of a camera and micro lens array;
said Shack-Hartmann Sensor combined with a focusing relay optical system;
wherein said Shack-Hartmann Sensor is first calibrated using a plane wave that removes any optical aberrations of said Shack-Hartmann sensor; and,
wherein said Focusing Shack-Hartmann sensor is then calibrated by using an ideal point source to remove optical aberrations of said focusing relay optics.

2. An improved measurement system using Shack-Hartmann wavefront detection for a projection optical system under test having an object Field Of View and an image plane comprising:
a Shack-Hartmann Sensor;
focusing relay optics placed between said image plane of said projection optical system under test and said Shack-Hartmann Sensor;
a point light source placed in front of and pointing towards said object Field Of View of said projection optical system under test; and,
wherein said focusing relay optics is placed such that the focus point of an image of a point light source that is projected by said projection optical system under test is matched to the focal length of said focusing relay optics.

3. An improved measurement system using Shack-Hartmann wavefront detection for a projection optical system under test having an object Field Of View and an image plane comprising:
a Shack-Hartmann Sensor;
focusing relay optics placed between said image plane of said projection optical system under test and said Shack-Hartmann Sensor;
an array of point light sources placed in front of and pointing towards said object Field Of View of said projection optical system under test; and,
wherein said focusing relay optics is placed such that the focus point of an image of a point light source from said array of point light sources that is projected by said projection optical system under test is matched to the focal length of said focusing relay optics.

4. The improved measurement system of claim 3 wherein said array of point light sources is two or more single mode fibers placed into an object plate made from a suitable material and polished to achieve the same object plane position facing said projection optical system under test's Field Of View for all said placed single mode fibers and the surface of said object plate.

5. The improved measurement system of claim 4 wherein said suitable material is stainless steel.

6. The improved measurement system of claim 4 wherein said suitable material is glass.
